(19) United States
(12) Patent Application Publication
(10) Pub. No.: US 2014/0258452 A1
(43) Pub. Date: Sep. 11, 2014

(54) Audible Content Delivery System

(71) Applicant: Randy Bruce Dunn, Orange, CA (US)

(72) Inventor: Randy Bruce Dunn, Orange, CA (US)

(21) Appl. No.: 14/146,388

(22) Filed: Jan. 2, 2014

Related U.S. Application Data
(60) Provisional application No. 61/776,129, filed on Mar. 11, 2013.

(51) Int. Cl. H04L 29/06; H04L 29/08

(52) U.S. Cl. CPC H04L 65/4069; H04L 67/22
USPC 709/217

(57) ABSTRACT

An audible content delivery system which tracks a user's interests and accesses, processes, and delivers relevant content to a user's device to be played in an audible format. The present invention includes a central communication unit communicatively interconnected with one or more user devices through a communications network. The central communication unit tracks content (e.g. web content) visited by the user device to identify relevant interests of the user. Using this information, the central communication unit identifies additional relevant content and retrieves the content for delivery to the user device. The content is extracted, cleaned up, and processed prior to delivery in a compressed format to the user device to decrease bandwidth usage. The user device decompresses the delivered content and audibly plays the content for the user.

### CROSS REFERENCE TO RELATED APPLICATIONS

I hereby claim benefit under Title 35, United States Code, Section 119(e) of U.S. provisional patent application Ser. No. 61/776,129 filed Mar. 11, 2013. The 61/776,129 application is currently pending. The 61/776,129 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a live information content relay and more specifically it relates to an audible content delivery system which tracks a user's online interests and accesses, processes, and delivers relevant content to a user's device to be played in an audible format.

2. Description of the Related Art

Any discussion of the related art throughout the specification should in no way be considered as an admission that such related art is widely known or forms part of common general knowledge in the field.

The transmission of media by way of audible format is well known. In addition to music, a broad range of verbal content has been available for many decades. Consumers can get live up-to-the minute news, including sports, weather, and financial information on a regular basis over various forms of radio and radio like transmission. Providers relay live content to consumers over wired and wireless via conventional radio transmission, satellite relay, over cable and other networks, in analog and digital formats of many varied types. For purposes of this document, all such forms of prior art live content transmission will be referred to as “radio” from here forward.

Providers of such radio tune the content delivery based on a mixture of consumer feedback and internal financial directives as part of running their business in order to offer a best value propositions to maximize revenue. Prior art radio offers very little in way of user adjustment to the content. Consumers can tune into different channels, which is typically the only method for changing the form of the content delivered. The only feedback to the provider is in the form of customer surveys and market studies, so the process of delivering desirable content to the consumer is slow to change and broad in order to reach the largest audience. Channels are organized into low resolution generic categories, such as sports, comedy, music, financial, etc. And within each of these categories the consumer has no specific control of the content. The result of this one size fits all approach is a compromise for the consumer who might have to wade through traffic reports to get updated sports information. In another example a consumer interested in hockey may have to wade through football, baseball, and other content just to get their content of interest. The consumer is still left highly dissatisfied if they prefer a mix of sports and financial information, especially if their interested are specific within each of these broad categories. However, the radio industry remains substantial, with reported 2012 global revenues of $32.5B. So it is clear that radio is a viable industry and a preferred means of disseminating information to consumers.

Timing is also problematic in the prior art of radio. It is well known that commuters listen to radio in their cars, often taking advantage of their free time to and from work and other short trips. This time is limited, with most commuters traveling an average of 40 miles a day. Radio providers' schedules do not necessarily align with commuters' schedules. Thus, a commuter may be subjected to information that is of little interest, and miss altogether information they would prefer to hear. Again the consumer is left dissatisfied and unable to affect the timing or content delivery of the information in any meaningful manner.

Many consumers now turn to the internet for access to live content. The internet has a vast amount of live information available, content of all sorts, with selection options far beyond that which is accessible by conventional radio stations. There exists today a myriad of general as well as high resolution highly focused and specialized websites provide massive amounts of live content available to consumers using fixed or mobile web enabled devices. Users access this information by directing their specific device to websites typically by touch screen, buttons, mice, verbal commands, or keyboards, and input is provide by a video display, or audio playback. The internet has live content that users would benefit from considering the precision and depth of the content available.

However internet access lacks the conventional convenience of radio. It is not always convenient, realistic, or even safe to maneuver through the various clicks and keyboard inputs to access this information. For example, while operating or driving a vehicle, it can be unsafe to use complex input methods to browse the web to access content or to safely be able to view the information once accessed. As another example, a consumer in the shower may also find it difficult to direct and access their device, preferring instead to fall back to conventional radio or television for information, and getting a less than satisfactory experience. Further, conventional websites are far too complex to be accessed in any simple manner, and jumping around between web pages and sites is even more complex should the user want to vary the content.

In order to make the control and navigation safer, a number of hands-free products are now available. The intent of some of these products is to enable control internet access devices so that consumers can safely control them when driving, in the shower, or when and wherever such a capability may be of value. One example of such a line of products are intelligent personal assistants, which are now commonplace in user device 30s, utilities that accept verbal commands and process them to provide answers, make recommendations, and performance tasks. Such utilities are targeted mainly at the user device 30 community where the user experience can be enhanced by the hands free operation they offer.

Although such products makes many operations safer for the mobile user, when applied to the aforementioned access to information in the classical radio sense, the fall far short of the task. The operator is forced to manually navigate the internet for the content desired, and directing the assistance within specific web pages is virtually impossible with any reasonable precision. The user is thus mired in commands and directions, and the experience is both frustrating and inefficient.

It may also seem that search tools, a common access method to web based data, could be used in conjunction with intelligent personal assistance to simplify the process. While search tools are good at finding relevant information over time, they all require a finite time to locate and index data. Timely late breaking news feeds as offered by prior art radio are not immediately accessible by search engines when they are fresh and new. In addition, users must still directly access the specific web pages for access to current relative new and information. And again, the intelligent assistants still require that the user work through many commands to access and navigate through and around data of interest. This is especially frustrating when trying to verbally navigate through web pages, and the user is often required to fall back to some manual intervention through buttons or touch screens in order to direct the tool to the information of interest.

The consumer is unfortunately unable to access the vast and specific live content of the internet in the highly desirable manner of radio. It is the intent of the present invention to provide a method that accesses live content of specific interest to the user from multiple web sources and delivers that content to consumers in an audible format with the ease of use of radio. The user gets access to the vast information set of the internet delivered in the familiar manner of radio, personalized to their preferences and easily controlled with minimal consumer direction.

Because of the inherent problems with the related art, there is a need for a new and improved audible content delivery system which tracks a user's online interests and accesses, processes, and delivers relevant content to a user's device to be played in an audible format.

### BRIEF SUMMARY OF THE INVENTION

The invention generally relates to a live information content relay method and system which includes a central communication unit communicatively interconnected with one or more user devices through a communications network. The central communication unit will track web content visited by the user device to identify relevant interests of the user of the device. Using this information, the central communication unit will identify additional relevant web content and retrieve the content for delivery to the user device. The content will be extracted, cleaned up, and processed prior to delivery in a compressed format to the user device. The user device will decompress the delivered content and convert text-to-audio prior to audibly playing the content for the user.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram showing one embodiment of the present invention.

FIG. 2 is a communications flow diagram illustrating the interconnectivity between various components of the present invention.

FIG. 3 is a flow chart illustrating the overall operation of a preferred embodiment of the present invention.

FIG. 4 is a flow chart illustrating exemplary training and content location functions of the present invention.

FIG. 5 is a flow chart illustrating exemplary extraction, cleanup and delivery functions of the present invention.

FIG. 6 is a flow chart illustrating exemplary conversion and broadcasting functions of the present invention.

### DETAILED DESCRIPTION OF THE INVENTION

### A. Overview of Invention.

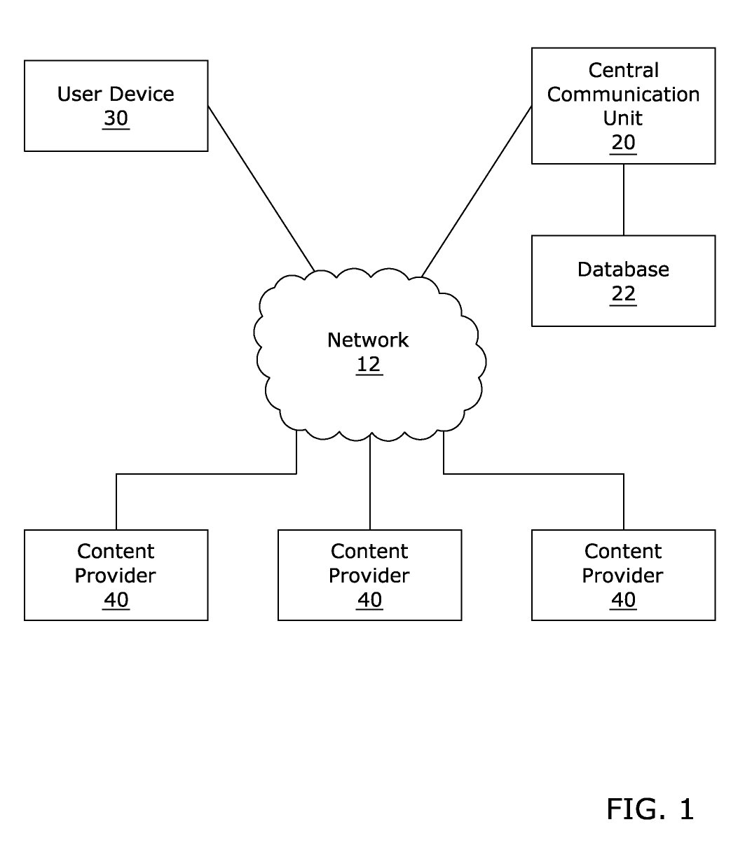

FIGS. 1 through 6 illustrate the present invention. The audible content delivery system generally includes a central communication unit 20 which is communicatively interconnected with one or more user devices 30 through a communications network 12. The central communication unit 20 will track web content 40 visited by the user device 30 to identify relevant interests of the user of the device 30. Using this information, the central communication unit 20 will identify additional relevant content and retrieve the content for delivery to the user device 30. The content 40 will be extracted, cleaned up, and processed prior to delivery in a compressed format to the user device 30. The user device 30 will decompress the delivered content and convert text-to-audio prior to audibly playing the content through its speaker for the user.

### B. Exemplary Communication Network.

The present invention may be utilized upon any communications network 12 capable of transmitting data including voice data and other types of electronic data. Examples of suitable communications networks 12 for the present invention include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). The present invention may communicate via a single communications network 12 or multiple communications networks 12 concurrently. Various protocols may be utilized by the electronic devices for communications such as but not limited to HTTP, SMTP, FTP and WAP (Wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary communications network 12 for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### C. Central Communication Unit.

The central communication unit 20 may be comprised of any central communication device or system where communications are preferably established with for performing the various functions of the present invention. While the singular term “unit” is used throughout the application, it should be appreciated that the central communication unit 20 may be comprised of a plurality of units which, together, perform the various functions set out herein.

The central communication unit 20 may be comprised of one or more server computers, cloud based computers, virtual computers, home computers or other computer systems capable of receiving and transmitting data via IP networks and the communication networks 12. The central communication unit 20 may be comprised of any electronic system capable of receiving and transmitting information (e.g. voice data, computer data, etc.).

The central communication unit 20 is preferably communicatively interconnected with the user device(s) 30 and content providers 40 through the communications network 12. As can be appreciated, a modem or other communication device may be required between each of the central communication units 20, user devices 30, content providers 40 and the corresponding telecommunication networks 12.

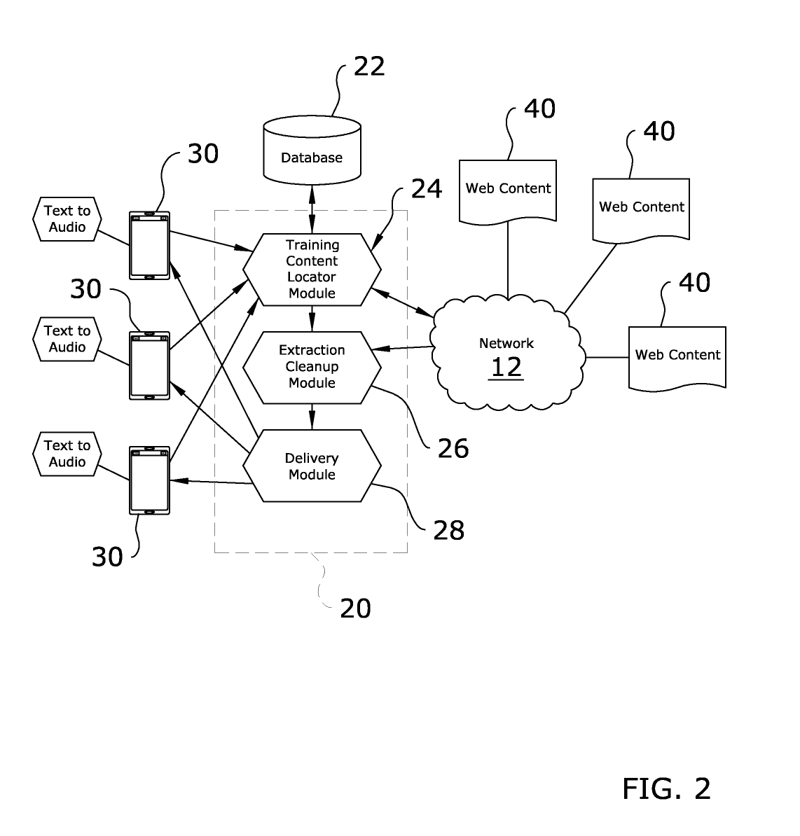

As best shown in FIGS. 1 and 2, the central communication unit 20 is preferably comprised of an off-location computing device (such as one or more server computers) which is adapted to transmit and receive data with the one or more user devices 30 and one or more content providers 40 of the present invention. The central communication unit 20 may be implemented across multiple devices or may be comprised of a single computing device. In embodiments implementing the central communication unit 20 across multiple devices, those devices may themselves be interconnected via a communications network 12.

The central communication unit 20 acts to perform the training, content location, extraction, cleanup, processing (i.e. compression), and delivery functions of the present invention. The central communication unit 20 may host a website or application which is utilized in combination with the one or more user devices 30 to perform the various functionalities of the present invention.

The central communication unit 20 will also generally include a database 22 for storing and accessing various data collected during operation of the present invention. The database 22 may be stored entirely on a single device or may be implemented across multiple devices. The database 22 may be integral with the central communication unit 20 or may be stored on a completely different device (or devices) which are communicatively interconnected with the central communication unit 20, such as through a communications network 12.

The central communication unit 20 will preferably host, or be communicatively interconnected with, the training content locator module 24, extraction cleanup module 26, and delivery module 28 of the present invention. Each module 24, 26, 28 may be implemented within the central communication unit 20 or on a separate device or devices which are communicatively interconnected therewith.

Each module 24, 26, 28, and the overall functionality of the central communication unit 20, will generally be implemented through use of a program storage device which is readable by a computer (either the central communication unit 20 itself or a separate computing device(s) which is communicatively interconnected therewith) to embody a program of instructions executable by the computer or the central communication unit 20 to perform the various functionalities of each module. The program storage device may be non-transitory.

### D. User Device.

The user device 30 may be comprised of any type of computer for practicing the various aspects of the present invention. The user device 30 receives, decompresses, and converts content received from the central communication unit 20 in an audible format. Thus, the user device 30 will preferably include a speaker and will be communicatively interconnected with the central communication unit 20, such as through the communications network 12.

While the singular term “device” is used to reference the user device 30 in the present application, it should be appreciated that the user device 30 may comprise multiple devices. By way of example, in some embodiments, a first user device 30 comprised of a computer will be utilized by the user for the training portions of the present invention, and a second user device 30 comprised of a mobile phone or tablet computer will be utilized by the user for receiving content from the central communication unit 20.

The user device 30 will preferably be adapted to communicate with the central communication unit 20 via the communications network 12. The user device 30 may connect with the central communication unit 20 via a website (i.e. through a web browser) or via a software application (i.e. by downloading the application from a mobile application store, such as GOOGLE PLAY STORE or APPLE ITUNES).

By way of example, the user device 30 can be a personal computer (e.g. APPLE® based computer, an IBM based computer, or compatible thereof) or tablet computer (e.g. IPAD®). The user device 30 may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The user device 30 may comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the present invention. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor together with an operating system operate to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### E. Content Providers.

As shown in FIGS. 1 and 2, content may be retrieved from one or more content providers 40 using the present invention. Content may take a number of forms, including audio, visual, textual, and any combination thereof. Content may include written or visual depictions of any subject matter accessible through the communications network 12, such as web pages.

Content providers 40 are generally comprised of web hosting services or the like which host the content being accessible through the communications network 12. The content providers 40, central communication unit 20, and user device 30 are each communicatively interconnected via the communications network 12. The central communication unit 20, as described below, will retrieve content from one or more content providers 40, compress and convert the content to pure audio format, and then deliver the content to the user device 30 to be audible played through its one or more speakers.

### F. Operation of Preferred Embodiment.

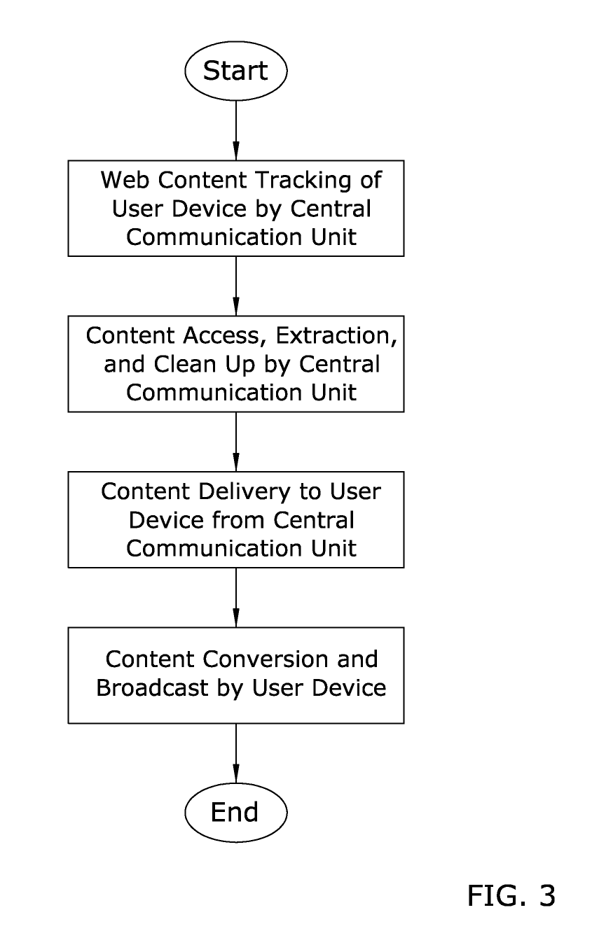

FIG. 3 illustrates the overall operation of a preferred embodiment of the present invention. Broadly stated, the central communication unit 20 will establish communications with one or more user devices 30, such as through a webpage or software application. The central communication unit 20 will then perform the training steps of the present invention, wherein the central communication unit 20 will track online activities of the user, such as any web content visited by the user, through the user devices 30 to learn the interests of the user. The user will also be given the option of providing feedback regarding their interests to correct or augment the training phase.

With interests identified through the training phase, the central communication unit 20 will identify content which is relevant to the user. This content may include content previously visited by the user in addition to content which the user may not have visited previously, but which the central communication unit 20 identifies as of potential interest to the user based on the training phase.

The central communication unit 20 will store in its database 22 the specifics of any content providers 40, such as web addresses, previously visited by the user. The central communication unit 20 will add additional content providers 40 which it identified as being relevant to the user's interests as well as those content providers 40 which were specifically selected by the user. The user may also be given the option of removing any content providers 40 from the retrieval list according to his/her interests.

The central communication unit 20 will then access and extract relevant content from the content providers 40 to be delivered to the user device 30. First, the content will be retrieved from the content providers 40 through the communications network 12 and stored on the central communication unit 20, such as in its database 22. The content will then be cleaned up as described herein prior to delivery to the user device 30. The content will be compressed for delivery and then transmitted through the communications network 12 in a compressed and processed state to the user device 30. The user device 30 will decompress the content and convert text-to-audio to be played audibly for the user.

i. Training Phase.

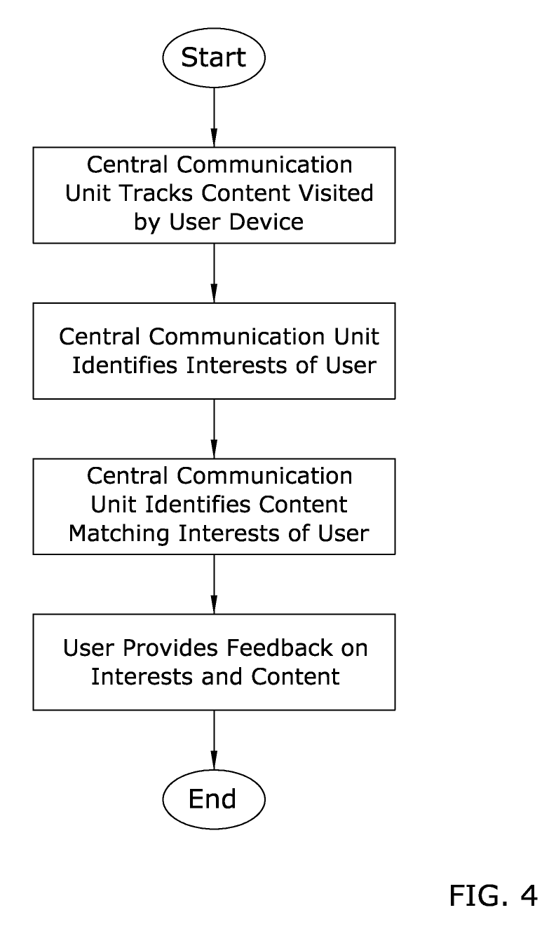

FIG. 4 is an exemplary flow chart illustrating the training functionalities of the present invention. The training and content locator module 24 comprises the selection of related content such as web sites and pages that contain information of interest to the user. Related content may include internet-based resources existing in many formats, with the majority of these resources accessed using conventional applications known generally as web browsers.

During the training phase, the user accesses the internet with a user device 30 with the intent of identifying the web sites, pages, articles, content, and so on, that are of interest to the user. This training may be accomplished in a number of ways. For example, the user device may establish connectivity with content through a portal which routes through the central communication unit 20 so that the content visited may be monitored. Alternatively, the user may utilize a web browser that is silently monitored by the central communication unit 20, making the process simple, natural, and quick to complete. A separate software application may or may not be installed on the user device 30 to effectuate such training

The results of the training may be processed and stored in the database 22. Variables stored within the database 22 may include the Internet addresses, web pages addresses, and general and specific content markers or key words that appear to be of interest to the user. It is important to note that it is not necessary for the user to delve into a web site beyond the first page in order for the present invention to function. The user may choose, however, to provide more specific detail on the information of interest for large web sites that may include substantial amounts of information that is not of interest to the user. The user repeats this process for all websites of interest, and can opt to go back at any future time in order to select additional content or remove content improperly identified as being of interest to them.

ii. Content Locator.

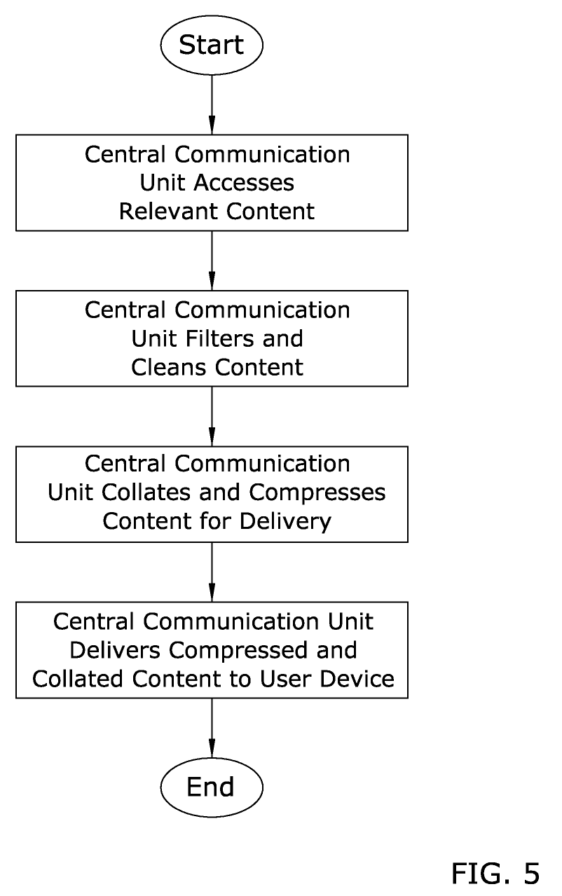

FIGS. 4 and 5 illustrate the content location functionalities of the present invention. After training, the content locator 24 of the present invention performs automated retrieval of related content that is of interest to the user. The content locator module 24 of the present invention automatically accesses related content such as content in a local database, content in a third-party database, content from online web sites and content from online web pages that were identified automatically or through feedback from the user during the training phase and have been stored in the database 22. Web site addresses are utilized directly, however since the pages of a website can change, the content locator 24 is responsible for sorting through the content or the web site pages in order to identify the content that matches those which were identified during the training process.

The user can affect the content selection process dynamically from their user device 30, such as through a software application. Feedback from the user is sent to the content locator 24 which can change the way the content located accesses content. For example, the content locator 24 can change focus from one site to a different site, or group of sites. This is akin to changing a radio station in conventional radio. But as opposed to conventional radio, the content can be very focused, such as on a specific site, specific content within a site, specific content within multiple sites, or more general content from multiple sites, and so forth. For example, sports news may be accessed from three different web sites, offering different stories, content, and views from different perspectives, and thus providing an enhanced user experience.

iii. Extraction and Cleanup.

FIG. 5 illustrates the extraction and cleanup functionalities of the present invention. The extraction cleanup module 26 retrieves the related content from the specific site locations pointed to by the content locator 24. The extraction cleanup 26 process also performs formatting cleanup operations to identify headlines from retrieved related content, strips off irrelevant data and formatting information, and organizes, adds content information tags, and reformats the content so that it is ready for delivery to the user as formatted content.

iv. Delivery.

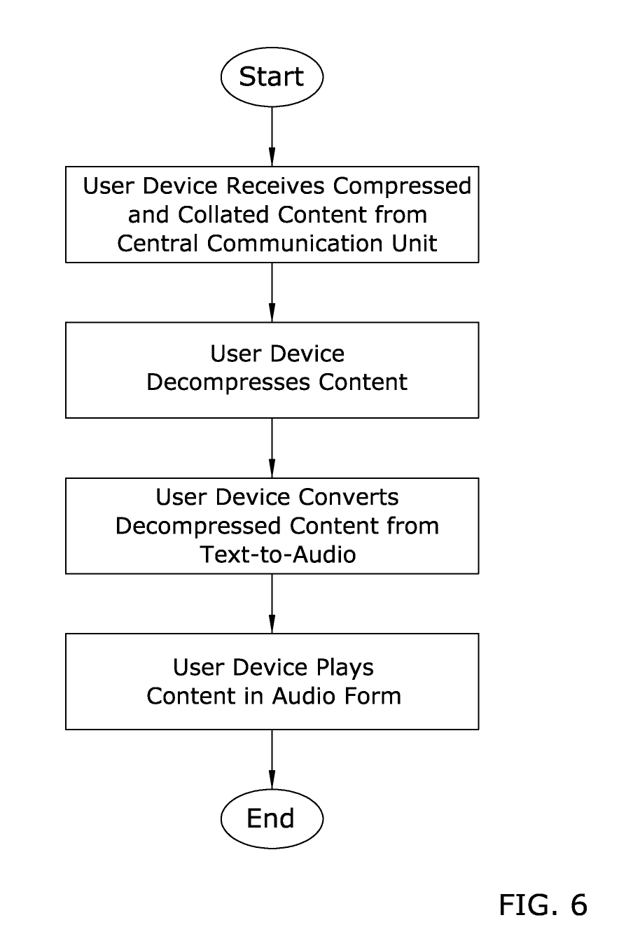

FIG. 6 illustrates an exemplary process for the delivery of related content to the user device 30. The delivery module 28 compresses, buffers and sends the formatted content to the user device 30. The formatted content may be delivered in a wide range of formats, but is preferably delivered in an non-audio file format (i.e. the formatted content is preferably not an audio file format). It is further preferable that the related content is delivered in text data format (e.g. a text file or HTML file) by the central communication unit 20 prior to being converted to audio by the user device 30 after delivery. Delivery of textual content will save bandwidth and thus increase the efficiency of the delivery module 28. It should be appreciated, however, that the formatted content may be delivered in other formats, such as binary, various encrypted formats, hexadecimal, and the like.

The delivery module 28 is responsible for queuing multiple data content blocks (articles, stories, etc.) from one or more sites identified by the content locator 24. Buffering enhances the response of the present invention such that the user experience is more responsive. The user can navigate through articles quickly, going forward and reverse, jumping to a change on content directed by the user through the content locator 24.

The user device 30 will generally include a user application that runs on the user device 30. One key function of the user application is to convert the delivered data into audible form such that the user can listen to the content over the user device 30. Thus, the received data/content may be converted to audio format, such as to an audio file, prior to being audibly played through the one or more speakers of the user device 30.

In order to minimize the amount of data delivered over the network 12, the data is compressed and in binary format. The user application decompresses the content, sorts the content out from the tags and other meta-data content that is used for data and control management functions. The user application may store the data in a local database for access by the user.

When activated, the user application converts the content into audio through a text-to-speech conversion process. The content is played out to the user from the user device 30 in a manner consistent with conventional radio. The content may be played in any number of manners known in the art for playing one or more audio files or audio sources through the one or more speakers of a user device 30. The content will thus be emitted audibly through the speakers to be heard by the user. In some embodiments, the content may be audibly played through the speakers during downloading of other content (i.e. streaming).

The user application also enhances the experience with pause, rewind, fast forward, skip, preview, and other DVR style controls to allow the user to select and advance through delivered content. The user application also allows the user to change stations, which changes the focus content of the delivered content through variables sent to the content locator 24.

The user application is also responsible for intelligently buffering content. This means that previous articles, for example, are retained on the user device 30, in case the user wants to backup and replay content. Future articles may thus be buffered in advanced, in case the user wants to skip to the next article or skip over several articles without waiting for the content to be downloaded. This again enhances the user experience by providing a dynamic and responsive feel.

Another aspect of the invention relates to the user application to content locator 24 feedback loop. The invention utilizes user control functions within the user application as feedback for its dynamic tuning process. If the user skips an article or story, the invention may tag that item as undesirable by injecting a weighting factor into the database 22 associated with the specific content. Likewise, content that is fully consumed by the user may be tagged as desirable content. In this manner the present invention hones its content delivery skills over time in an organic manner that does not rely on complex user configuration or setup effort. This enhances the value of the present invention over the prior art systems of manually configuring, and profiling content delivery, and enables vastly more complicated tuning patterns than could be done conventionally.

Another aspect of the present invention is the ability to embed the training content locator module 24 and extraction cleanup module 26 functionality directly into a website via a website “connector” software component. In summary, this connector is an interface between the website content and the extraction cleanup module 26 and delivery module 28. Supported audio commands are sent in text format to the central communication unit 20 and on to the user device 30. Each audio command is sent with a numerical code, so when the user device 30 detects a valid command, the code is sent back through the extraction cleanup module 26 and delivery module 28 to the connector. The website performs the requested action based on the code. If a new page is displayed on the same website, a new set of audio commands are then sent using the connector, thus providing page-specific audio commands for accessing the webpage. The connector also handles user login and secure data transfer.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a communications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A method of delivering content to a device, comprising:
an identifying step of identifying areas of interest for a user;
a retrieving step of retrieving related content to said areas of interest;
a delivery step of delivering said related content to a first user device; and
a playing step of audibly playing said related content by said first user device.

2. The method of claim 1, wherein said identifying step comprises tracking online activities of said user.

3. The method of claim 2, wherein said identifying step comprises the step of said user selecting one or more of said areas of interest.

4. The method of claim 1, including a processing step of processing said related content by a central communication unit prior to said delivery step.

5. The method of claim 4, wherein said processing step is comprised of removing irrelevant data and formatting information from said related content.

6. The method of claim 4, wherein said processing step comprises the step of compressing said related content prior to said delivering step.

7. The method of claim 6, wherein said conversion step comprises the step of decompressing said related content by said first user device.

8. The method of claim 1, including the step of providing a central communication unit for performing said identifying step, said retrieving step, and said delivery step.

9. The method of claim 1, wherein said related content is comprised of text data.

10. The method of claim 1, including a conversion step of converting said related content to an audio file, wherein said playing step comprises said first user device audibly playing said audio file.

11. The method of claim 1, including a tracking step of tracking online activities of said user.

12. The method claim 11, wherein said tracking step is comprised of tracking said online activities on a second user device, wherein said second user device is not said first user device.

13. A method of delivering content to a user device, comprising:
a tracking step of tracking online activities of a user on a user device;
an identifying step of identifying areas of interest for said user;
a retrieving step of retrieving related content to said areas of interest for said user;
a processing step of processing said related content by a central communication unit;
a compression step of compressing said related content by said central communication unit;
a delivery step of delivering said related content to a user device by said central communication unit;
a conversion step of converting said related content into an audio file by said user device and
a playing step of playing said audio file by said user device.

14. The method of claim 13, wherein said processing step comprises the step of removing irrelevant data and formatting information from said related content.

15. The method of claim 14, wherein said processing step comprises the step of organizing and adding content information tags to said related content.

16. The method of claim 13, including the step of buffering said related content by said central communication unit prior to said delivery step.

17. The method of claim 13, including the step of running a user application on said user device, wherein said user application is adapted to allow said user to pause, rewind, fast forward, and skip said related content as said related content is being played on said user device.

18. The method of claim 17, including the step of identifying and tagging as undesirable said related content skipped by said user.

19. A non-transitory program storage device readable by a computer, embodying a program of instructions executable by the computer to perform method steps for delivering content to a user device based on a user's interests, said method steps comprising:
a tracking step of tracking online activities of a user on a first user device;
an identifying step of identifying areas of interest for said user;
a retrieving step of retrieving related content to said areas of interest for said user;
a processing step of processing said related content by a central communication unit;
a compression step of compressing said related content by said central communication unit;
a delivery step of delivering said related content in text data format to a second user device by said central communication unit;
a conversion step of converting said related content into an audio file by said second user device; and
a playing step of playing said audio file by said second user device.

20. The non-transitory program storage device readable by a computer, embodying a program of instructions executable by the computer to perform method steps for delivering audible content to a user device based on a user's interests of claim 19, wherein said first user device is selected from the group consisting of a laptop computer, a personal computer, and a tablet computer and wherein said second user device is selected from the group consisting of a laptop computer, a tablet computer, and a mobile phone.
